(19) United States
(12) Patent Application Publication
(10) Pub. No.: US 2008/0263138 A1
(43) Pub. Date: Oct. 23, 2008

(54) Method and system for managing specimen data

(76) Inventors: Royce C. Heslep, Katy, TX (US); James John O'Sullivan, The Woodlands, TX (US)

Correspondence Address: Anthony W. Hong, Suite 1200, 3730 Kirby Drive, Houston, TX, 77098, US

(21) Appl. No.: 11/973,824

(22) Filed: Oct. 9, 2007

Related U.S. Application Data
(60) Provisional application No. 60/849,972, filed on Oct. 6, 2006.

(51) Int. Cl. G06F 15/16; G06F 3/048; G06F 17/30; G06F 7/06

(52) U.S. Cl. 709/203; 715/780; 707/10; 707/103 R; 707/9; 707/5; 707/E17.01; 707/E17.017

(57) ABSTRACT

An innovative system and method for laboratories, hospitals and others to manage stored specimens is described and claimed. One problem commonly encountered by medical researchers is the inability to effectively and efficiently track the large number of specimens generated in the course of their research. In an environment comprised of multiple researchers—each working on varied projects and often needing to interact—it is necessary to employ a centralized, fast and efficient way to track the location of stored samples and to identify changes or removed samples. A Method and System for Managing Specimen Data (or “VSM”) is a web-based software application designed to efficiently manage specimen samples. Examples of the VSM include the VSM software application and a database—each residing on a remote server—that displays web pages accessible by registered and logged in users through a standard web browser via a secure internet or intranet connection found on a client computer. A single or multiple registered and logged in user or users have the ability via web browser and secure internet or intranet connection to add or remove one specimen or multiple specimens simultaneously from the VSM database and to track the location and status of samples entered into the VSM database (e.g. whether a specimen remains in storage or has been removed for further analysis) as well as when they were removed and by whom. In at least some examples, specimens can be located by, among other criteria, owner name, clinical trial and/or location. Users have the ability to locate available space.

### REFERENCE TO RELATED PROVISIONAL APPLICATION

This application claims the benefit of the filing date of U.S. provisional patent application Ser. No. 60/849972, filed Oct. 6, 2006, by Royce C. Heslep, James J. O'Sullivan, Jonathan A. Walsh and Patrick B. Beaman and entitled A METHOD AND SYSTEM FOR MANAGING SPECIMEN DATA.

### BACKGROUND

1. Field of the Invention

This invention relates generally to the field of medically related software applications.

2. Background of the Invention

This application sets forth an innovative system and method for laboratories, hospitals and others to manage stored specimens.

One problem commonly encountered by medical researchers is the inability to effectively and efficiently track the large number of specimens generated in the course of their research. Specimens are placed in specimen vials on a rack in a freezer for storage. A large hospital or research lab can generate thousands of specimens in a short period of time, which makes the tracking and retrieval process cumbersome and inefficient. Often specimen samples are lost or misplaced. In an environment comprised of multiple researchers—each working on varied projects and often needing to interact—it is necessary to employ a centralized, fast and efficient way to track the location of stored samples and to identify changes or removed samples.

Currently, laboratories and hospitals attempt to use stand alone software, such as Excel, or manual tabulation to track frozen tissue, fluids, and other specimens (such as tissue slides and paraffin blocks) at a high cost in efficiency and time.

### SUMMARY OF SOME EXAMPLES OF THE INVENTION

A Method and System for Managing Specimen Data (hereinafter also referred to as Visual Specimen Manager or “VSM”) is a web-based software application designed to efficiently manage specimen samples, defined herein to include but not be limited to tissue, fluids, paraffin preserved specimens, frozen specimens, refrigerated specimens and specimens stored in vials, test tubes, on slides or in or on other media (collectively referred to herein as vials, samples, specimen samples or specimens). At least some examples of this web-based software application enable users such as researchers and other hospital staff to remotely locate, track, and modify the data associated with stored specimen samples.

Examples of the VSM include the VSM software application and a database—each residing on a remote server—that displays web pages accessible by registered and logged in users through a standard web browser via a secure internet or intranet connection found on the desktop client computer (hereinafter referred to as desktop computer, client, or client computer) running any one of multiple platforms (e.g. Windows based PC, Macintosh and Linux).

All features of the VSM are accessible, in at least some examples of the VSM, through the VSM dashboard page, which serves as a user's landing page, i.e. the first web page that the user's browser displays after the user successfully logs in. At least in some examples, the dashboard for non-administrator users includes portals for displaying that user's samples (“My Samples), for running reports, for adding or removing samples, for changing user profile and for carrying out simple and advanced searches. Administrator users access a dashboard page that also includes portals, for managing data and for user administration. The version that is displayed after user login is determined by the privileges granted when the user is added to the system.

The portal for adding/removing samples takes the user to visual representations of samples. Sample locations are represented by icons that correspond at least in some examples to the physical location, such as the building name, floor, room number, freezer name, freezer rack, and box. The icons are displayed in hierarchical form in some such examples so that using a mouse to click an icon representing one level of the hierarchy activates a hypertext link that opens the next lower level in the hierarchy. This intuitive locational hierarchy helps the user pinpoint, in some examples, the building in which the specimen is located, the floor within that building, the room within that floor, the freezer within that room, the rack within that freezer, the box within that rack and the individual vial within that box. The users in such examples have the ability to map each specimen sample to a particular slot in specimen boxes located in particular freezer racks.

A single or multiple registered and logged in user or users have the ability via web browser and secure internet or intranet connection to add or remove one specimen or multiple specimens simultaneously from the VSM database and to track the location, status of samples entered into the VSM database (e.g. whether a specimen remains in storage or has been removed for further analysis) as well as when they were removed and by whom. In at least some examples, specimens can be located by, among other criteria, owner name, clinical trial and/or location. Users have the ability to locate available space.

There are required fields to ensure the recording of complete information when a specimen is received. Users have the ability to lock or unlock a particular sample vial whose data is stored on the VSM database. Only specified users, such as project team members in some examples, have the ability to access locked vials to make changes to the data stored in the VSM database with respect to that vial. In such examples, any user can access an unlocked vial.

The dashboard includes an extensive search feature, which simplifies and expedites the process of locating individual specimens or groups of specimens. An intelligent search feature assists in locating specimens based on complete or partial words. Users have the ability in some examples to sort search results based on selected criteria.

Dashboards include an additional portal that enables administrator and non-administrator users to generate reports. Individual user reports show, for example, activity on specimens of interest. Administrator reports in some examples help manage freezer or other storage space. Printouts are available for grouping of specimens, such as a rack of frozen specimen, making it easy to find a specimen by comparing a rack printout to the actual freezer rack while retrieving a specimen vial.

The administrator dashboard provides a manage data portal and a user administration portal. The manage data portal enables administrator users in some examples to modify the hierarchy tree. The user administration portal enables administrator users to add new users, freezer or other specimen storage space, buildings and rooms to the system.

The VSM system uses state of the art security features. Login is password protected. Each user is assigned privileges based on their needs. Privileges include limited view, full view, and editing rights. System access can be limited to particular departments. Users who are inactive for longer than a predetermined amount of time are timed out.

This VSM system works on a single or multi-tier client-server architecture with the client comprised of multiple work stations that can access the server and database simultaneously. The data are stored on the server or on a database accessible by the server. Using a standard web browser, the client—once built-in security procedures are carried out—accesses the application and employs the aforementioned functionality depending on the user's or administrator's access level. The client stores an electronic cookie for use in establishing authentication.

### BRIEF DESCRIPTION OF THE DRAWINGS

FIG. 1 is a flow chart that explains the login process for at least some examples of the VSM.

FIG. 2 is a flow chart setting forth the options available to non-administrator and administrator users from at least some examples of the VSM dashboard.

FIG. 3A is a screen shot of an administrator dashboard.

FIG. 3B is a screen shot of a non-administrator user dashboard.

FIG. 4 is a flow chart explaining an example of the process for performing a simple search on the VSM system.

FIG. 5 is a screenshot of the hierarchy tree displayed in at least some examples of the VSM that allows users to pinpoint the location of a sample to a specific slot of a box stored on a specific freezer shelf.

FIG. 6 is a flowchart describing how a user selects slots on boxes depicted on a hierarchy tree for adding/editing sample vials or deleting sample vials.

FIG. 7 is a screenshot of what a user sees when he selects a box depicted on the hierarchy tree.

FIG. 8A is a flow chart explaining how a user adds specimen vial information.

FIG. 8B is a flow chart explaining how a user edits specimen vial information.

FIG. 9 is a screenshot of the entry form for entering data regarding a specimen vial.

FIG. 10 is a flow chart explaining how a user deletes specimen vial information.

FIG. 11 is a flow chart explaining how a user changes user details.

FIG. 12 is a flow chart explaining users generate reports.

FIG. 13 is a flow chart explaining how an administrator user manages users.

FIG. 14 is a flow chart explaining how an administrator manages the hierarchy tree.

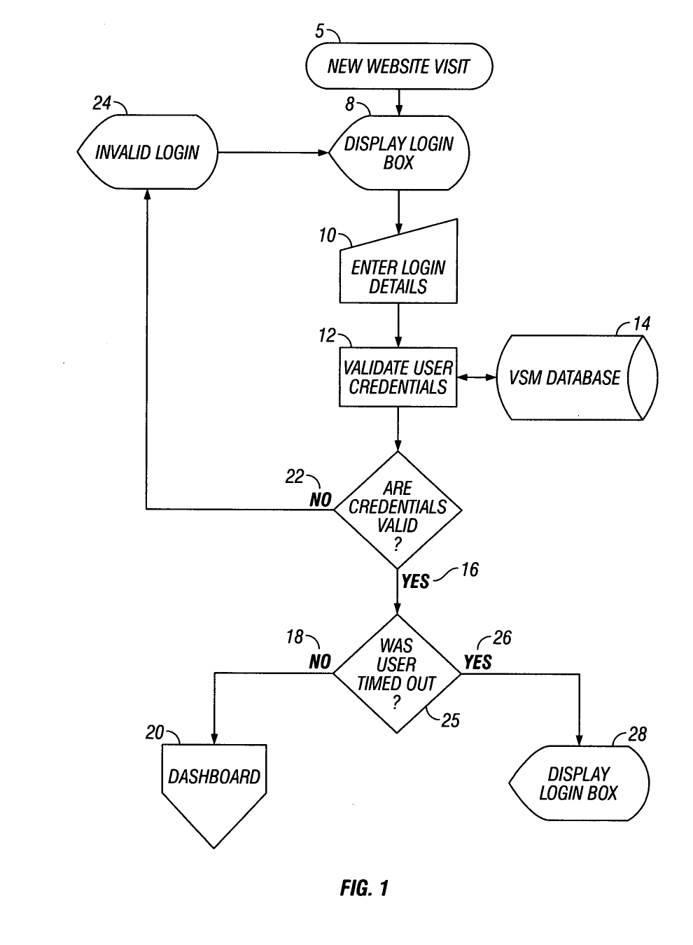

The functionality, methods and systems described and disclosed in FIGS. 1-14 can be employed to manage not only frozen tissue specimen data but other specimen data as well.

### DETAILED DESCRIPTION OF THE PREFERRED EMBODIMENTS

Two levels of security in at least some examples involves validation of user credentials and timing out as illustrated in FIG. 1. A user making a new website visit 5 to the VSM in such examples views the login box 8 webpage generated by the VSM application residing on the server. To gain access to the VSM, the user must enter login details 10 in the client, including in at least some examples user name and password. The user's login details are validated 12 by the server against data for approved users contained in the VSM database 14. The VSM database 14 in at least some examples is stored on a remote server. If the credentials are validated 16 and the user has not been timed out 18, the user then accesses the dashboard web page 20 generated by the VSM application.

If the user's credentials are not valid 22, then the user receives an invalid login page from the VSM 24 and the user is sent back to the display login page 8. On every web page request excluding a web page request associated with an initial login, the VSM in at least some examples compares the last time the current user accessed a VSM web page against the current time 25. If the difference is less than the timeout limit set within the VSM, the remote server sends the requested page to the user. (When logging in initially, the requested page sent from the remote server containing the VSM application is in at least some examples the dashboard page 20.) If the time difference, however, is greater than the timeout limit set within the VSM application 26, the VSM presents the user with the login screen 28. The user follows the usual log in process as described herein. If the user logs in successfully the user is presented with the page the user requested originally.

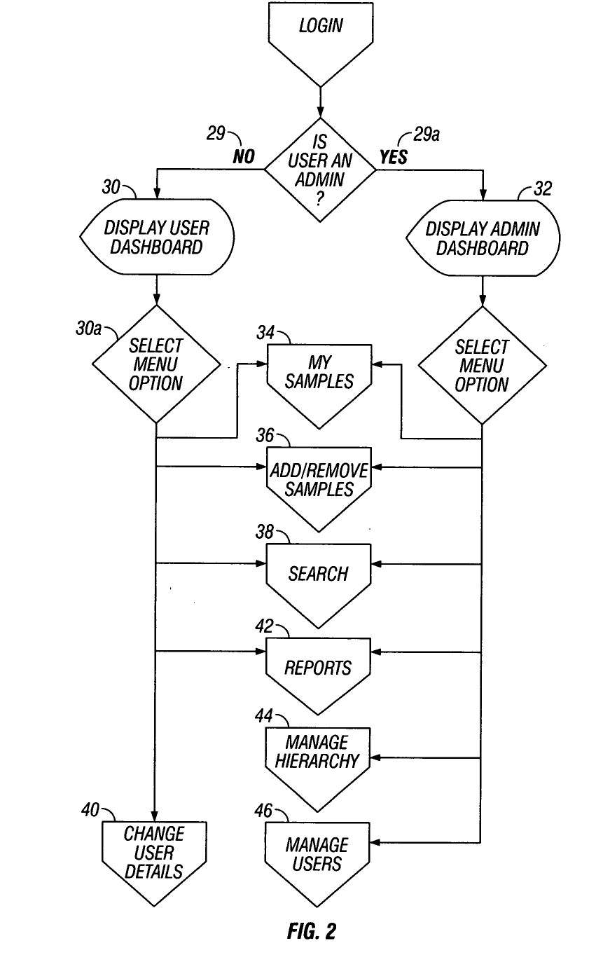

The dashboard serves as the user's gateway to various features of at least one example of the VSM and is the first page retrieved from the VSM application on the remote server when a user first logs in. The options available to a user from the dashboard page at least in some examples are set forth in FIG. 2. Upon login in such examples, non-administrator users 29 view a user dashboard page 30 generated by the VSM application while administrators 29a view an administrator's dashboard page 32. The user's dashboard presents the user with options 30a including in some examples viewing the user's samples (“My Samples”) 34, adding/editing/removing samples 36, searching 38, changing user details 40 and generating reports 42. After accessing any one of the features available to the user on the dashboard by clicking the appropriate icon on the dashboard, the user has the option of returning to the dashboard page 30 and accessing any one of the other features available to a user 34, 36, 38, 40 and 42. On every VSM page except for the login page the user returns to the dashboard at anytime by selecting the Dashboard link.

Additional security in some examples of the VSM arises from the degree of functionality given different users. An administrator's dashboard page at least in some examples permits someone validated as an administrator to manage the locational hierarchy applicable to samples 44 and to manage users 46.

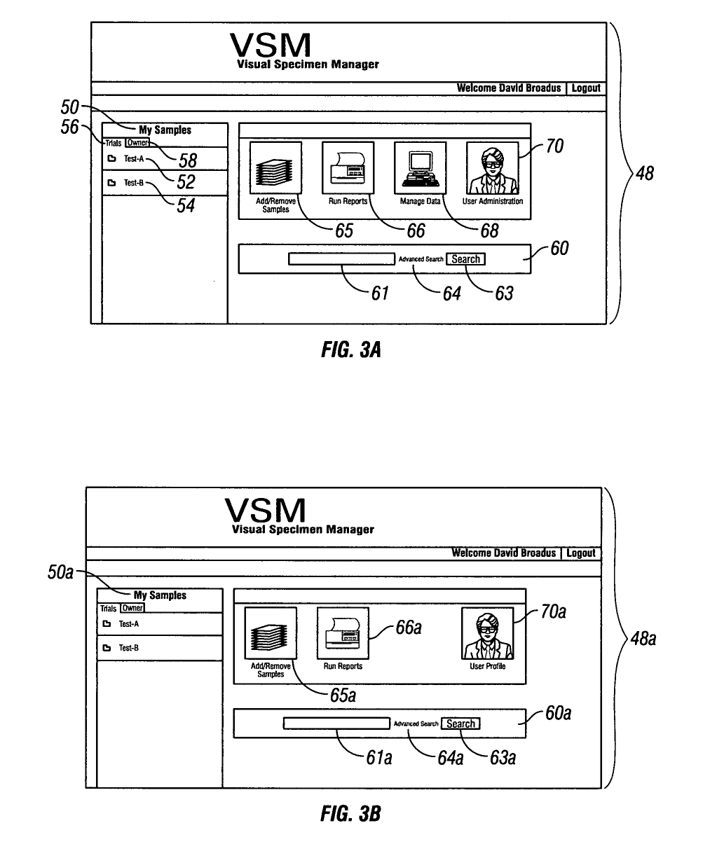

FIG. 3A is an example of a screenshot of an administrator VSM dashboard 48 web page generated by the VSM application on the server. In this example, the My Samples section 50 on the dashboard provides a quick overview of that user's clinical trials 52, 54, which the user accesses by using a mouse to click on the Trials tab 56 under My Samples 50. The clinical trials are identified by hypertext link 52, 54. Clicking on an individual link displays a webpage on the client computer that identifies the user's samples with respect to that clinical trial. The user can also use the mouse to click on the Owner tab 58 to access VSM generated web pages identifying samples by owner name in some examples. Clicking on the owner name displays that owner's samples. Each sample (whether under the Trials or Owner tab) is identified by its name in the form of a hypertext link. Clicking on such a sample link gives the user access to an additional web page displaying data with respect to the sample. Sample data accessible from the My Samples section 50 of a dashboard 48 can be viewed but not altered by the user.

A non-administrator user dashboard page is illustrated in FIG. 3B. The non-administrator dashboard page 48a is identical to the administrator dashboard page illustrated in FIG. 3A except that the non-administrator dashboard lacks a manage data icon, FIG. 3A, 68, and has a user profile icon 70a instead of a user administration icon FIG. 3A, 70. The operation of the My Sample section on administrator, FIG. 3A, 50, and non-administrator dashboards, FIG. 3B, 50a, is identical.

In some examples, the dashboard also gives administrators and non-administrator users access to a search bar, as set forth in FIG. 2, 38, FIG. 3A, 60 and FIG. 3B, 60a. In such examples, the search feature displays a field, FIG. 3A, 61 and FIG. 3B, 61a, in which the user can enter the name of the sought after item, including for example a sample name, an investigator's name, the name of a building or the name of a clinical trial.

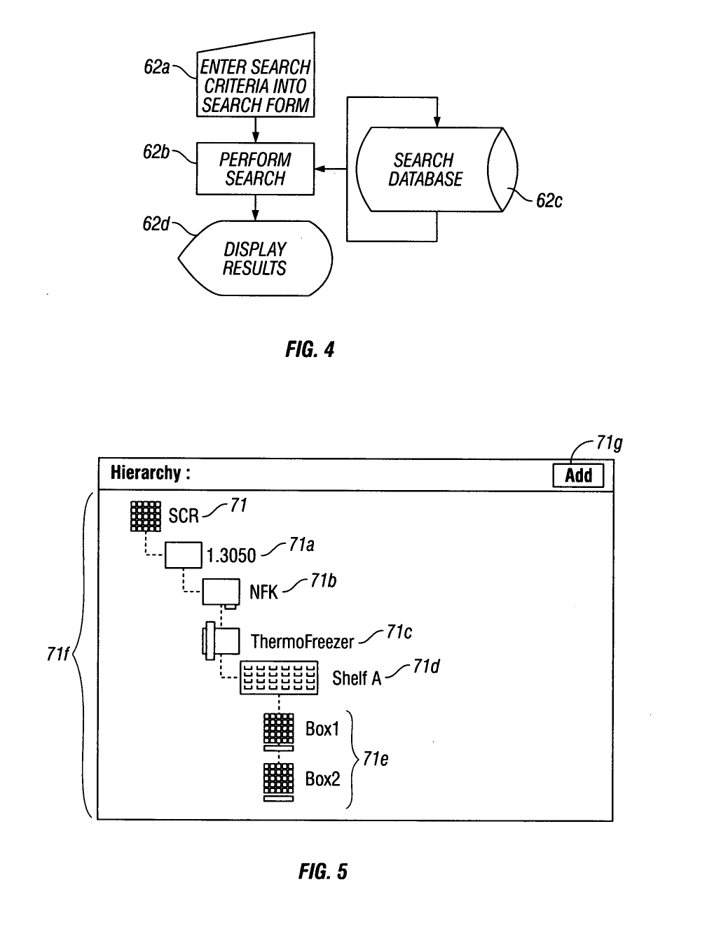

A user who chooses to employ the search bar, FIG. 2, 38, FIG. 3A, 60 and FIG. 3B, 60a, on the dashboard, enters the search criteria into the search form page displayed on the client computer, FIG. 4, 62a, and initiates the search by the VSM application residing on the server by, in some examples, pressing the enter key on the client computer keyboard, FIG. 4, 62b and in other examples by clicking on the search button, FIG. 3A, 63 and FIG. 3B, 63a, on the dashboard. The term is compared to data stored in the search database, FIG. 4, 62c, stored on a remote server. The user receives a web page from the VSM application on the remote server displaying any matches from the search database, FIG. 4, 62d.

In some examples, clicking the advanced search link, FIG. 3A, 64 and FIG. 3B, 64a, brings up a menu of criteria on which to base a search. In at least one example, the search criteria include (i) information on the sought after vial, investigator or additional information, (ii) the match (with the option of choosing a match on any part of the search term or a match based on a complete match with the entire search term) and (iii) the order of the search results (with the user able to choose among search score, time, reverse score and reverse time).

The dashboard in at least some examples also allows non-administrator users and administrators to add/remove samples, as illustrated in FIG. 2, 36, FIG. 3A, 65 and FIG. 3B, 65a. In such examples, using the mouse to click on the add/remove icon on the dashboard allows the user to identify and record the building, floor, room, freezer, freezer rack and box of a given sample. As illustrated in FIG. 5, clicking the add/remove sample icon on the dashboard displays a web page on which an icon 71 representing the highest level of the locational hierarchy is displayed. In at least some examples, the top level of the locational hierarchy is the building in which a sample might be located 71. Clicking on the building icon displays the data for that building including in at least some examples icons representing the hierarchy immediately below. In the example set forth in FIG. 5, the next lower hierarchy represents floors 71a within the building that holds specimen samples. In this example, using the mouse to select icons in each successive level of the hierarchy generates nodes for, in addition to building 71, floor 71a, room 71b, freezer 71c, freezer shelf 71d and box 71e. The entire hierarchy tree is displayed in FIG. 5, 71f.

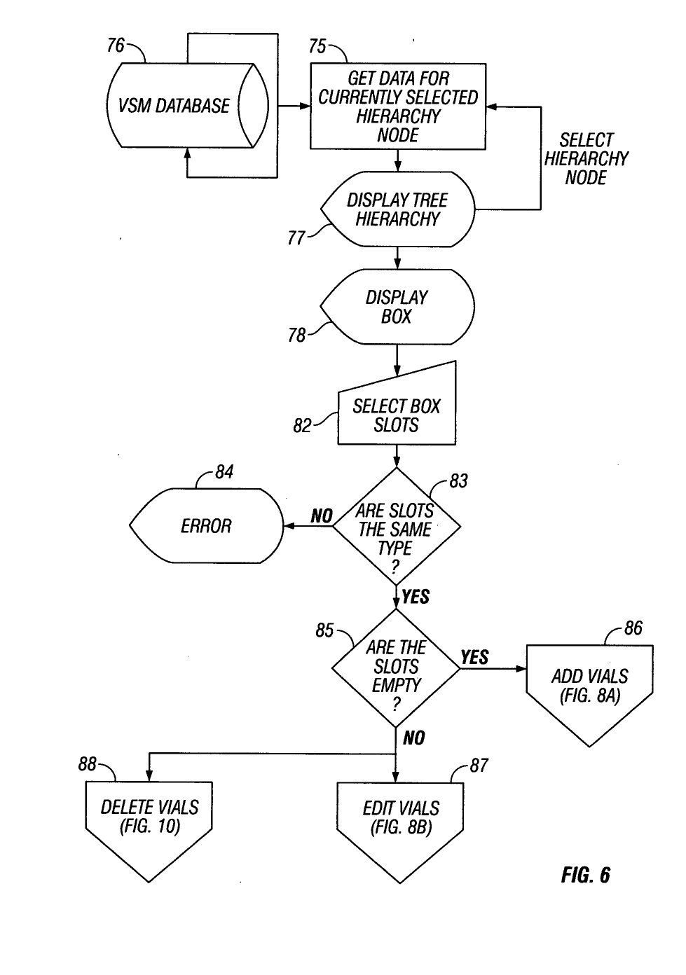

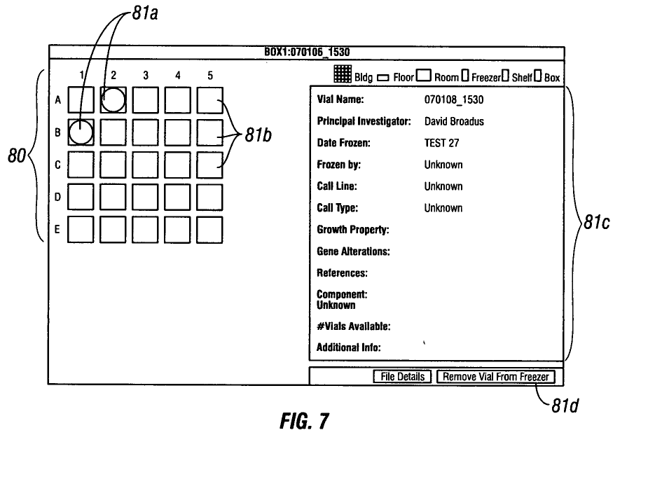

FIG. 6 illustrates how a user uses the add/remove sample function. The user selects the add/remove sample icon on the user dashboard, FIG. 2, 36, FIG. 3A, 65 and FIG. 3B, 65a, and selects icons, FIG. 7, 71-71e and FIG. 6, 75, for successively lower levels of the hierarchy. In the process, the user receives data 75 for each selected node from the database 76 in the form of web pages from the VSM application until the entire tree hierarchy, FIG. 5, 71f and FIG. 6, 77, including the lowest node, in this example, specimen sample storage box, FIG. 5, 71e and FIG. 6, 78, is displayed. As illustrated in FIG. 7, the box 80 displays the number of rows and columns set up by the administrator based on the freezer type with either specimen sample vials previously added FIG. 7, 81a or empty cells, FIG. 7, 81b, in each box slot. Clicking on a particular specimen vial within that box FIG. 7, 81a displays information about that particular specimen vial, FIG. 7, 81c.

To add or remove sample specimens, the user clicks and selects one or more box slots FIG. 6, 82. If the slots are of different types 83 such as slots that are filled and those that are empty in some examples, then the user receives an error message web page from the VSM 84. If the selected slots are empty 85, then the user has the ability to add 86 a new vial or vials. If the selected slots are filled, then the user has the ability to edit 87 or delete 88 the vial data.

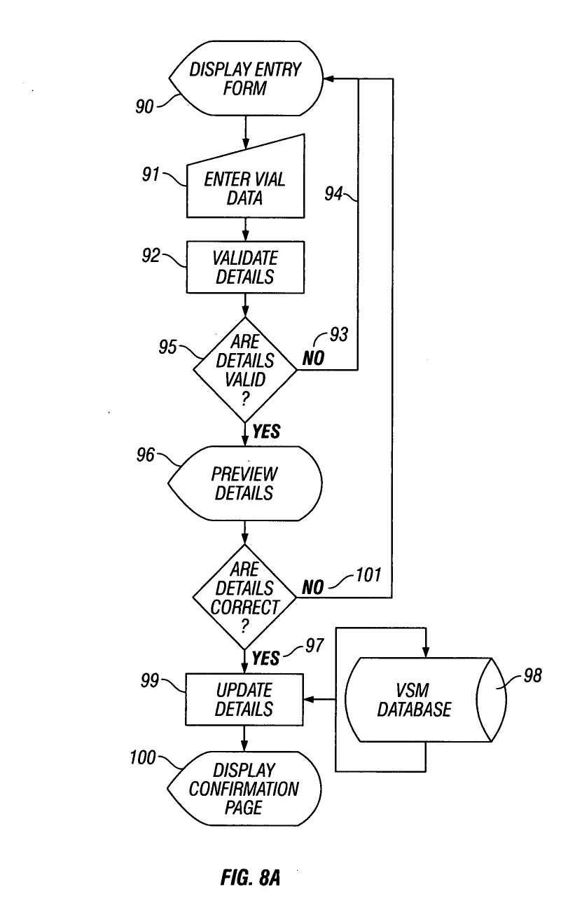

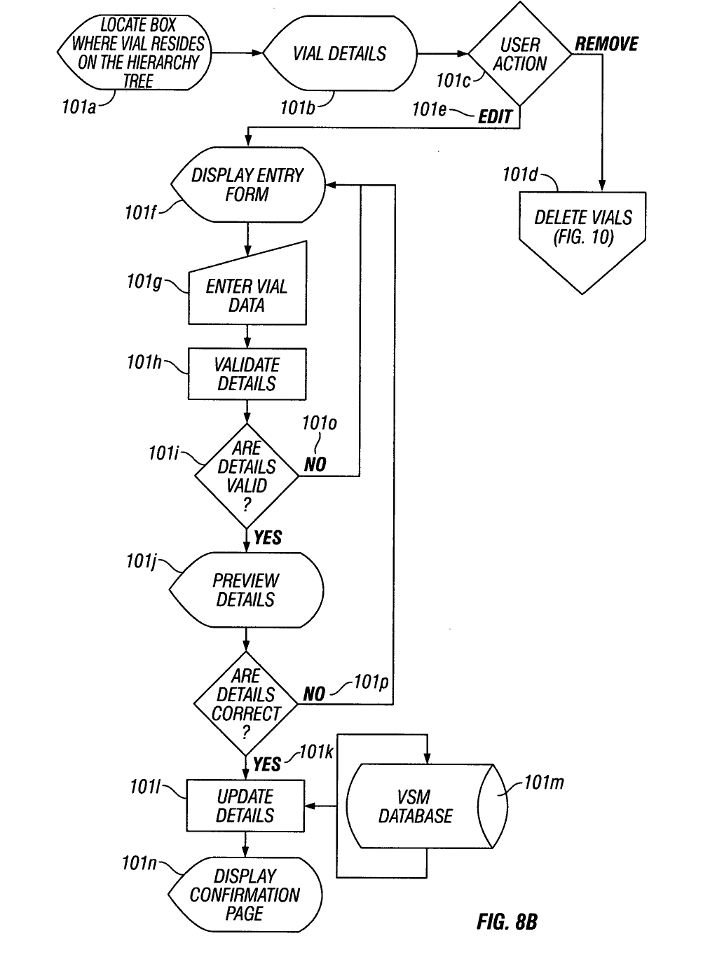

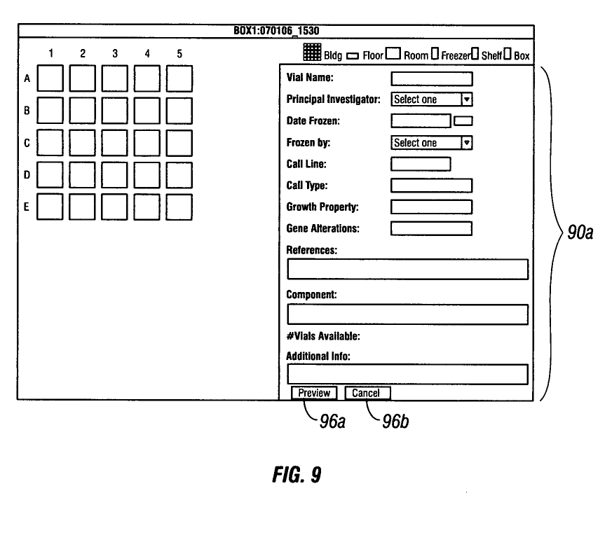

To add specimen sample information, the user in at least some examples accesses the entry form web page from the VSM, FIG. 8A, 90, and FIG. 9, 90a. The user enters vial data into the entries on the form 91 displayed on the client browser and the VSM application validates details 92 based on a predetermined rule set that fulfills user requirements. If the details are not valid 93, then the user must reenter details 94 on the entry form 92. Once the details are validated 95, the user previews the specimen details preview web page displayed on the client browser, FIG. 8A, 96 by clicking on the preview button, FIG. 9, 96a. The user confirms the correctness of the details by clicking the save button 97, and thereby submitting the form from the client computer, the VSM database 98 on the remote server updates the details 99. The VSM application on the server sends the client a confirmation web page 100. If the preview indicates incorrect details 101, then the user clicks cancel, FIG. 9, 96b, and must resubmit details on the entry form 90.

FIG. 8B illustrates how a user edits specimen vial information. The user pulls up the box where the specimen vial of interest resides from the locational hierarchy, FIG. 8B, 101a and clicks on the vial symbol in the box to receive a web page from the VSM application providing vial details 101b. The user has the option 101c of deleting the specimen vial 101d or editing 101e the vial information. To edit, the user starts with the display entry web page, FIG. 7, 81c and FIG. 8B, 101f. The user enters data into the form 101g from the client computer and the VSM validates 101h. If the new data is validated by a predetermined set of rules set forth in the VSM 101i that fulfills user requirements, the user's client computer receives a preview details web page 101j from the VSM. If the user confirms the correctness of the details by mouse click or keyboard stroke on the client 101k, then the server 101l updates the VSM database 101m and sends the user a confirmation page 101n. If the details are not valid 101o or are incorrect based on the preview page 101p, the user receives a display entry form 101f and reenters the vial data 101g.

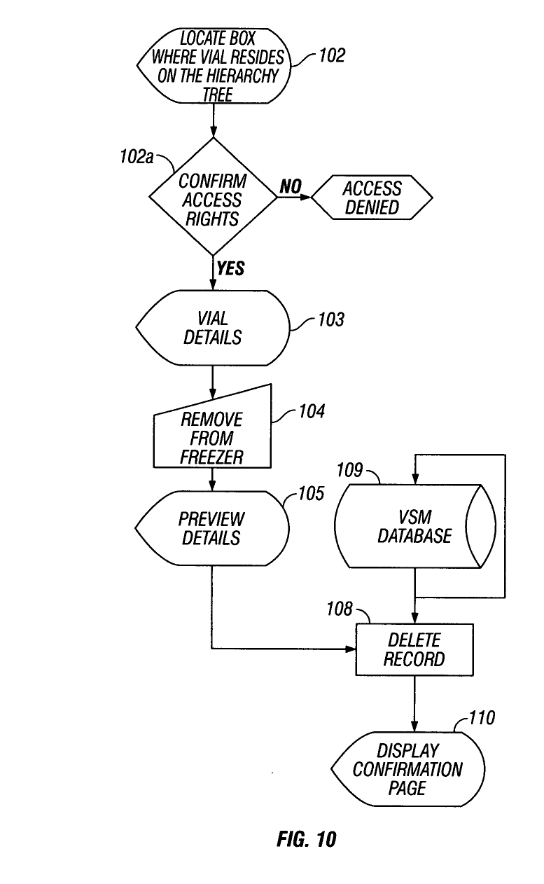

Users have the ability to remove a vial from a freezer box, in some examples to indicate that the specimen vial has been physically discarded. The user locates the box where the vial resides on the hierarchy tree FIG. 10, 102. In at least some examples, if the VSM confirms that the user has access privileges 102a, then the user is able to click on the vial symbol within the box, FIG. 7, 81a, to obtain details regarding that vial, FIG. 7, 81c and FIG. 10, 103. To indicate that the vial has been removed, the user in some examples clicks the remove from freezer button FIG. 7, 81d and FIG. 10, 104. The server sends the user a web form previewing the details of the impending deletion, FIG. 10, 105. After previewing, the user then sends a command from the client causing the server to delete 108 the record from the VSM database, FIG. 10, 109. The client receives a confirmation web page 110.

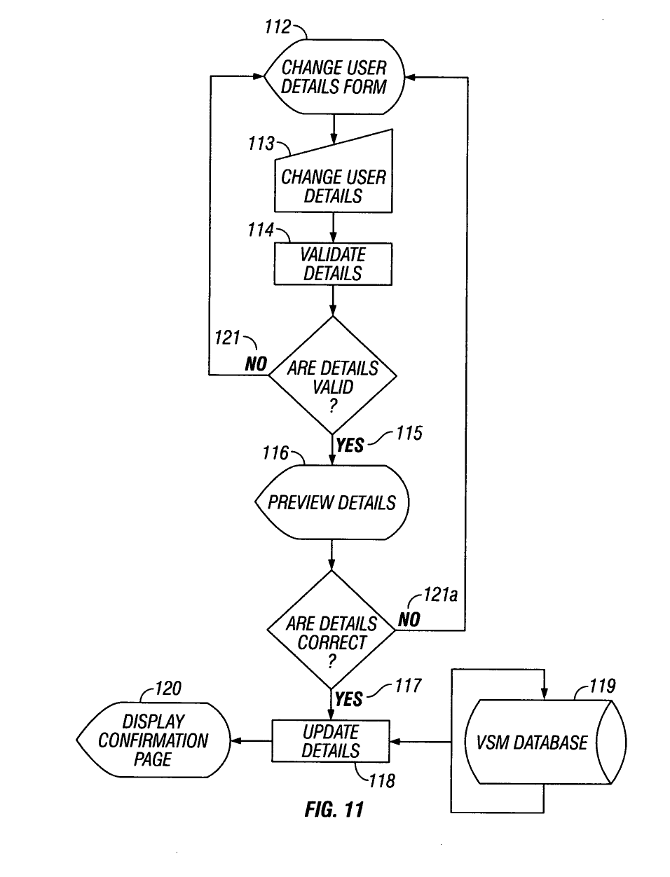

The non-administrator dashboard enables non-administrator users to change user profile as illustrated in FIG. 2, 40, FIG. 3B, 70a, and FIG. 11. A user accesses the user details web page form by clicking the user profile link, FIG. 3B, 70a and FIG. 11, 112, on the user dashboard, FIG. 3B, 48a, and enters changes in the pertinent fields 113. The application validates those details 114, and if they are validated 115, the client receives a preview details page 116 from the server. If the details are correct 117, the application updates the user details 118 by sending them to the VSM database 119, which sends the user's client computer a confirmation page 120. If the user details are not valid 121 or a preview of the details 116 shows the details to be incorrect 121a, the user changes 113 the user details form 112 accordingly.

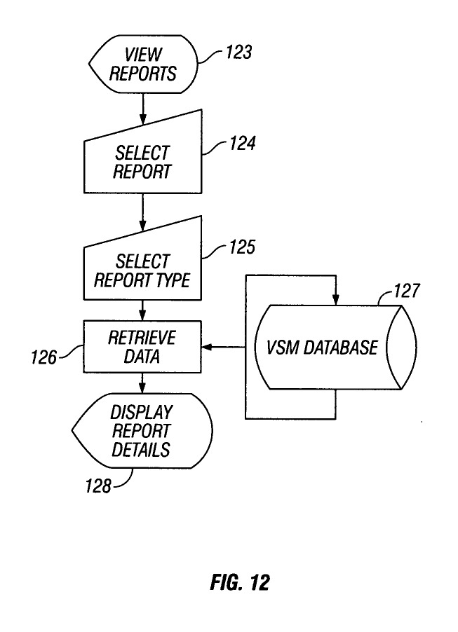

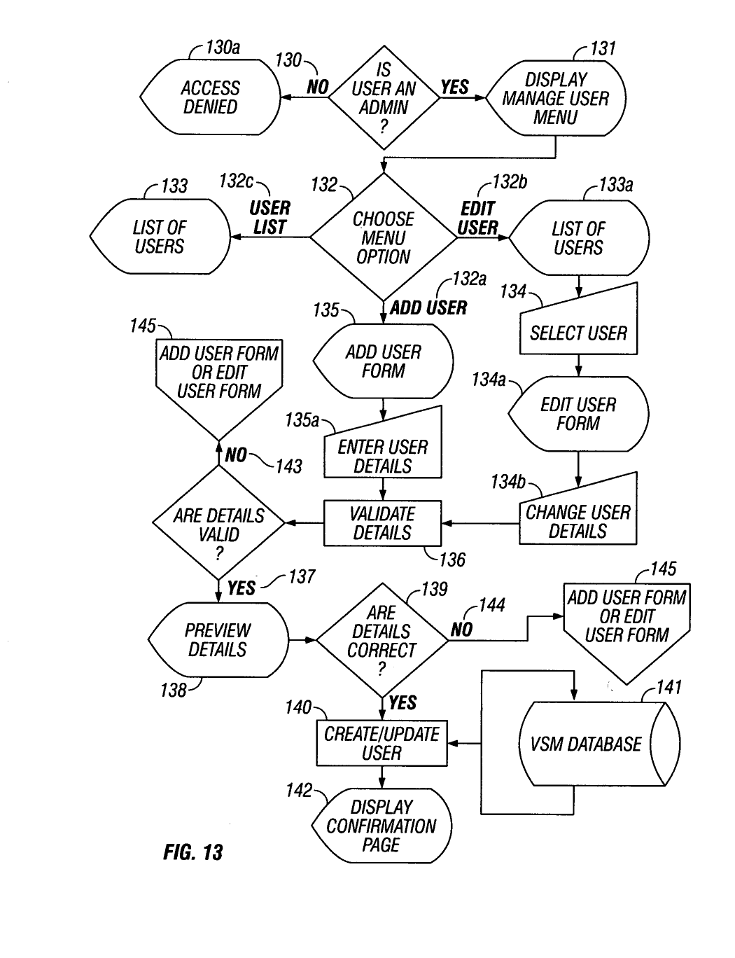

Dashboards enable users to run reports by clicking in some examples the Run Reports link on the dashboard, FIG. 2, 42, FIG. 3A, 66 and FIG. 3B, 66. For such users, clicking on the Run Reports link opens a list of reports (which is in some examples a spreadsheet) that can be viewed, FIG. 12, 123, or saved to a folder on the client computer of the user's choosing. In at least some examples, the user selects the report 124 and reporting format 125. The data for the report is retrieved 126 from the VSM database 127 and the client receives a display report details web page from the server.

An administrator dashboard provides a portal for managing users, FIG. 2, 46 and FIG. 3A, 70. Non-administrator users, FIG. 13, 130, are denied access, FIG. 13, 130a. Clicking on the user administration icon, FIG. 3A, 70, in at least some examples displays a web page with a manage user menu, FIG. 13, 131, via the web browser on the administrator client computer. The manage user menu contains three hypertext links, FIG. 13, 132, allowing the administrator to add user 132a, edit user 132b or list users 132c. Clicking the list users link 132c on the manage user menu 131 displays a list of users on the client computer, FIG. 13, 133, pulled from the server. To edit the list of approved users, the administrator's client receives a web page with a list of users 133a from the server. The user selects the user 134, submits that request to the server, receives from the server an edit user form 134a, and changes the user details on that form 134b. To add users, the user chooses that menu option 132, 132a, receives an add user form 135 from the server, enters user details 135a on the form, The VSM validates 136 the details of submitted with an add user form 135 or an edit user form 134a, in accordance with the VSM's predetermined set of rules as required by user needs. If the details are valid 137, then the user's client receives a preview details web page 138. If the details are correct 139, the user in some examples mouse clicks to submit the details 140 to update the VSM database 141 on the server. The client receives and displays on the client browser a confirmation page 142. If the details are not valid 143 or are not correct 144, then the server sends the user the add user or edit user form to begin the adding user or editing process anew.

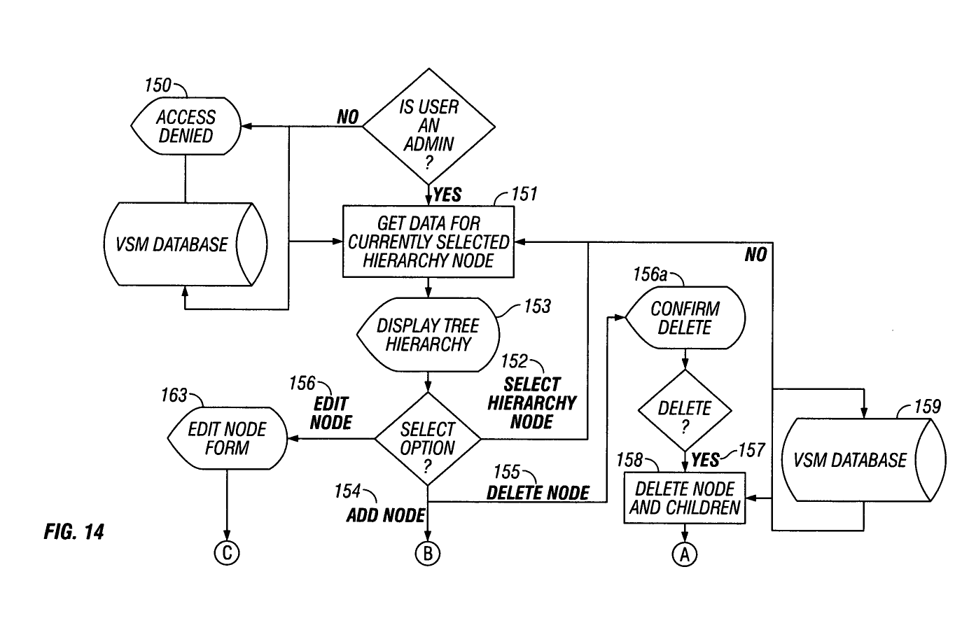

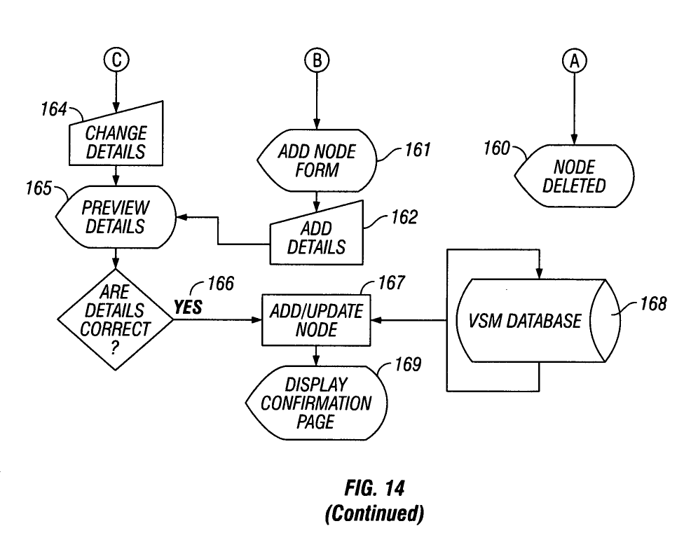

As illustrated in FIG. 3A, 70, administrator dashboards also permit administrators the ability to modify the hierarchy tree. Non-administrator users cannot access this functionality as illustrated in FIG. 14, 150. Administrators click on the user administration icon on the dashboard, FIG. 3A, 70, to display the node representing the highest level of the locational hierarchy 151, which in some examples is the building where a specimen sample is located, and clicks on that icon and each icon representing successively lower levels of the hierarchy 152 until the entire hierarchy tree is being displayed 153. The administrator's browser displays a page with options to add a node 154, to delete a node 155 or to edit a node 156.

By clicking on any node in the hierarchy, the administrator displays on his client's browser in at least some examples the edit/delete dialog box web page generated by the server. The administrator clicks on the delete button in the dialog box, receives a confirm delete page 156a, confirms the delete by keyboard stroke or mouse click 157, thereby causing the server 158 to update the VSM database 159 by deleting the selected hierarchy node and all of the nodes (if any) that depend on that node (i.e. children) 160.

To add a node, the administrator clicks add on the hierarchy tree page, FIG. 5, 71g, to display an add node form, FIG. 14, 161, dialog box. The administrator in at least some examples has the ability to add any node type that appears on the hierarchy (e.g. building, floor, room, freezer, rack or box) and to name the node as node details 162. The administrator can also select additional details for the freezer (e.g. model number), shelf (e.g. dimensions) and box (e.g. rows and columns).

To edit a node, the administrator mouse clicks on any icon representing a node in the hierarchy to generate an edit/delete dialog box 163 in some examples. The administrator has the same ability to change the same details for the selected node that the administrator can add to a new node 164.

Changed or added details appear on the client browser as a preview details page 165. If the details are correct 166, the server updates the node or adds a new node 167 and updates the VSM database 168 accordingly. The administrator receives a confirmation page from the server 169.

What is claimed is:

1. A client system for sending information regarding specimen data to a server comprising:
an identifier component that identifies a user;
a display component for displaying web pages and web page templates into which said specimen data can be entered;
a component that, in response to an action by the user of the client system, sends said specimen data to the server system.

2. The client system of claim 1 wherein said display component is a browser.

3. The client system of claim 1 wherein said action involves using a mouse to click on a button displayed on a web page.

4. The client system of claim 1 wherein said client system is a device comprising at least one microprocessor.

5. The client system of claim 4 wherein said device is a workstation or handheld device.

6. A server system for storing specimen data comprising:
a data storage component storing said specimen data;
a receiving component for receiving said specimen data;
a computational component for computing said specimen data;
an information retrieval component for retrieving from said data storage component specimen data.

7. The server system of claim 6 wherein said computational component comprises at least one microprocessor.

8. The server system of claim 6 wherein said data storage component is a database server.

9. A method for managing specimen data comprising
storing said specimen data on a server system;
displaying said specimen data on a graphical user interface located on a client system;
sending said specimen data to said server from said client system.

10. The method recited in claim 9, wherein said specimen data being sent from said client system modifies or replaces specimen data previously stored on the server system.

11. The method recited in claim 9 further comprising the step of organizing data concerning the location of specimen in the form of a locational hierarchy.

12. The method recited in claim 9 further comprising the step of allowing different levels of access to said specimen data for different users.

13. The method recited in claim 9 further comprising the step of allowing users to search said specimen data.

14. The method recited in claim 9 further comprising the step of allowing users to generate customized reports.

15. The method recited in claim 11 further comprising the step of giving administrators the option of adding, editing or deleting nodes on the locational hierarchy.
